(19) United States
(12) Patent Application Publication
(10) Pub. No.: US 2026/0333541 A1
(43) Pub. Date: Oct. 22, 2026

(54) LIGHTING CONTROL APPARATUS

(71) Applicant: Mitsubishi Electric Mobility Corporation, Tokyo (JP)

(72) Inventors: Takashi HIRATSUKA, Tokyo (JP); Hiroshi ISHIZAKI, Tokyo (JP); Yasuhiro NUKISATO, Tokyo (JP)

(73) Assignee: Mitsubishi Electric Mobility Corporation, Tokyo (JP)

(21) Appl. No.: 19/119,294

(22) PCT Filed: Dec. 13, 2022
(86) PCT No.: PCT/JP2022/045795

§ 371 Date: Apr. 8, 2025

(51) Int. Cl. H05B 45/48; B60Q 1/14; B60Q 1/34; H05B 45/10; H05B 45/325; H05B 45/3725; H05B 47/155

(52) U.S. Cl. CPC H05B 45/48; B60Q 1/1415; B60Q 1/34; H05B 45/10; H05B 45/325; H05B 45/3725; H05B 47/155

(57) ABSTRACT

A lighting control apparatus drives a plurality of semiconductor light sources, including a headlight and a signal light, connected in series. A lighting control circuit of the lighting control apparatus controls a width of a period in which the output voltage of a switched-mode power supply is supplied to each of the plurality of semiconductor light sources in each cycle of the PWM control to control a light emission amount of each of the plurality of semiconductor light sources. The lighting control circuit divides the plurality of semiconductor light sources into a plurality of groups and divides a cycle of the PWM control into a plurality of partial sections allocated to the plurality of groups, respectively, to divide a period in which the output voltage of the switched-mode power supply is supplied for each group.

### TECHNICAL FIELD

The present disclosure relates to a lighting control apparatus performing lighting control on a plurality of semiconductor light sources.

### BACKGROUND ART

A vehicle in which a semiconductor light source made up of a semiconductor light-emitting element such as a light-emitting diode (LED) and a semiconductor laser (LD) is used for an illumination such as a headlight and a signal light has become common. For example, Patent Document 1 described hereinafter discloses a lighting control apparatus for a vehicle controlling a plurality of semiconductor light sources.

In a technique in Patent Document 1, the plurality of semiconductor light sources are connected in series, and are driven by pulse width modulation (PWM) control in which voltage is supplied in a cycle. In the PWM control, a width of a period in which the voltage is supplied to each of the semiconductor light sources in each cycle (a so-called “duty ratio”) is controlled to control a light emission amount of each semiconductor light source.

Herein, although voltage drop occurs in lighting in the semiconductor light source, when the plurality of semiconductor light sources are connected in series as with Patent Document 1 to perform constant current control using a switched-mode power supply, the plurality of semiconductor light sources can be turned on at the same time by one switched-mode power supply. That is to say, in the PWM control, a period in which the voltage is supplied to each semiconductor light source can be overlapped with each other.

### PRIOR ART DOCUMENTS

### Patent Document(s)

Patent Document 1: Japanese Patent No. 6916668

### SUMMARY

### Problem to be Solved by the Invention

The number of the semiconductor light sources mounted to a vehicle increases as application of the semiconductor light source to the lighting apparatus of the vehicle proceeds. In the meanwhile, a heat generation amount of the lighting apparatus increases, and downsizing of the lighting control apparatus is also required to achieve a headlight design which cannot be achieved in a halogen headlight. In the technique in Patent Document 1, the period in which the voltage is supplied to each semiconductor light source can be overlapped with each other; thus, even when the number of the semiconductor light sources increases, the period in which the voltage is supplied to each semiconductor light source is ensured, and a required light emission amount can be obtained, However, when the number of the semiconductor light sources turned on at the same time increases, the voltage drop gets large; thus, a switched-mode power supply having high maximum output voltage needs to be prepared or the number of the switched-mode power supplies needs to be increased, and such a configuration leads to increase of the b eat generation amount and increase of size of the lighting control apparatus, The present disclosure is to solve the above problems, and an object of the present disclosure is to ensure a required light emission amount while suppressing voltage drop occurring in a plurality of semiconductor light sources in a light source lighting apparatus driving the plurality of semiconductor light sources connected in series.

### Means to Solve the Problem

A lighting control apparatus according to the present disclosure includes: a switched-mode power supply supplying voltage to a plurality of semiconductor light sources, including a headlight and a signal light, connected in series; and a lighting control circuit driving the plurality of semiconductor light source by pulse width modulation (PWM) control supplying output voltage of the switched. mode power supply to the plurality of semiconductor light sources in a cycle and controlling a width of a period in which the output voltage of the switched-mode power supply is supplied to each of the S plurality of semiconductor light sources in each cycle of the PWM control to control a light emission amount of each of the plurality of semiconductor light sources, wherein the lighting control circuit divides the plurality of semiconductor light sources into a plurality of groups and divides a cycle of the PWM control into a plurality of partial sections allocated to the plurality of groups, respectively, to divide a period in which the output voltage of the switched-mode power supply is supplied for each group.

### Effects of the Invention

According to the lighting control apparatus in the present disclosure, the lighting periods of the plurality of the semiconductor light sources are divided for each group; thus, the number of the semiconductor light sources turned on at the same time can be reduced, and voltage drop is suppressed. In the partial section, the lighting period of each semiconductor light source can be overlapped with each other ; thus, a length of the lighting period of each semiconductor light source can be ensured, and a required light emission amount can be obtained.

These and other objects, features, aspects and advantages of the present disclosure will become more apparent from the following detailed description when taken in conjunction with the accompanying diagrams.

### BRIEF DESCRIPTION OF DRAWINGS

FIG. 1 is a diagram illustrating a configuration of a lighting control apparatus according to an embodiment 1.

FIG. 2 is a timing diagram illustrating an example of an operation of the lighting control apparatus according to the embodiment 1.

FIG. 3 is a timing diagram illustrating a comparative example of an operation of a lighting control apparatus.

FIG. 4 is a diagram Illustrating a modification example of the configuration of the lighting control apparatus according to the embodiment 1.

FIG. 5 is a timing diagram illustrating a modification example of the operation of the lighting control apparatus according to the embodiment 1.

FIG. 6 is a timing diagram illustrating an example of an operation of a lighting control apparatus according to an embodiment 2.

### DESCRIPTION OF EMBODIMENT(S)

### Embodiment 1

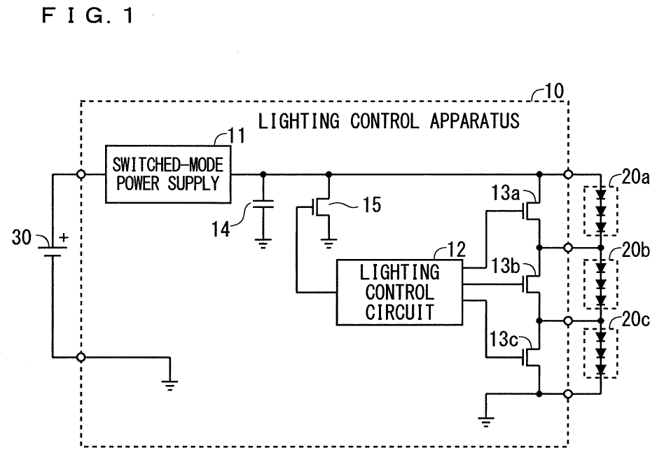

FIG. 1 is a diagram illustrating a configuration of a lighting control apparatus 10 according to an embodiment 1. The lighting control apparatus 10 according to the embodiment 1 is mounted to a vehicle to drive a plurality of semiconductor light sources 20 including a headlight and a signal light of the vehicle. The plurality of semiconductor light sources 20 driven by the lighting control apparatus 10 are connected in series. Herein, a semiconductor light-emitting element constituting the semiconductor light source 20 is an LED, but may be the other semiconductor light-emitting element such as an LD, for example.

The present embodiment indicates an example that the lighting control apparatus 10 drives three semiconductor light sources 20a, 20b, and 20c. Herein, it is specifically assumed that a semiconductor light source 20a is a low beam of the headlight, a semiconductor light source 20b is a high beam of the headlight, and a semiconductor light source 20c is a signal light. Examples of the signal light include a daytime running light (also referred to as “daylight” hereinafter), a position light (also referred to as “small light” or “road light”), and a turn signal lamp (also referred to as “turn signal” hereinafter).

As illustrated in FIG. 1, the lighting control apparatus 10 includes a switched-mode power supply 11, a lighting control circuit 12, a switch elements 13a, 13b, and 13c, a smoothing capacitor 14, and a discharge circuit 15.

The switched-mode power supply 11 supplies voltage to the plurality of semiconductor light sources 20 (a low beam 20a, a high beam 20b, and a signal light 20c) connected in series, A power source is supplied to the switched-mode power supply 11 from a battery 30. The smoothing capacitor 14 smoothing output voltage and the discharge circuit 15 for discharging electrical charge stored in the smoothing capacitor 14 are connected to an output terminal of the switched-mode power supply 11.

The lighting control circuit 12 performs PWM control of supplying the output voltage of the switched-mode power supply 11 to the plurality of semiconductor light sources 20 in a cycle to drive the plurality of semiconductor light sources 20. The lighting control circuit 12 controls a width of a period in which the output voltage of the switched-mode power supply 11 is supplied to each of the plurality of semiconductor light sources 20 in each cycle of the PWM control to control a light emission amount of each of the plurality of semiconductor light sources 20.

The switch elements 13a, 13b, and 13c are made up of a metal-oxide-semiconductor field-effect transistor (MOSFET), for example, and are connected in series between the output terminal of the switched-mode power supply 11 and a ground terminal. The switch elements 13a, 13b, and 13c are parallelly connected to the low beam 20a, the high beam 20b, and the signal light 20c, respectively. The lighting control apparatus 10 switches ON and OFF of the switch elements 13a, 13b, and 13c, thereby controlling timing at which the output voltage of the switched-mode power supply Il is supplied to each of the low beam 20a, the high beam 20b, and the signal light 20c. That is to say, the lighting control apparatus 10 switches OFF the switch element 13a when the voltage is supplied to the low beam 20a, switches OFF the switch element 13b when the voltage is supplied to the high beam 20b, and switches OFF the switch element 13c when the voltage is supplied to the signal light 20c.

The switched-mode power supply 11 performs constant current control of keeping current flowing in the low beam 20a, the high beam 20b, and the signal light 20c constant. Thus, a period in which the lighting control circuit 12 supplies the voltage to each of the low beam 20a, the high beam 20b, and the signal light 20c, that is to say, a lighting period of each of the low beam 20a, the high beam 20b, and the signal light 20c may be overlapped with each other. Thus, a length of the period in which the voltage is supplied to each of the low beam 20a, the high beam 20b, and the signal light 20c can be easily ensured, and a light emission amount required by each light source can be obtained.

The lighting control circuit 12 divides the plurality of semiconductor light sources 20 into a plurality of groups and divides a cycle of the PWM control into a plurality of partial sections allocated to the plurality of groups, respectively, to divide a period in which the output voltage of the switched-mode power supply 11 is supplied for each group.

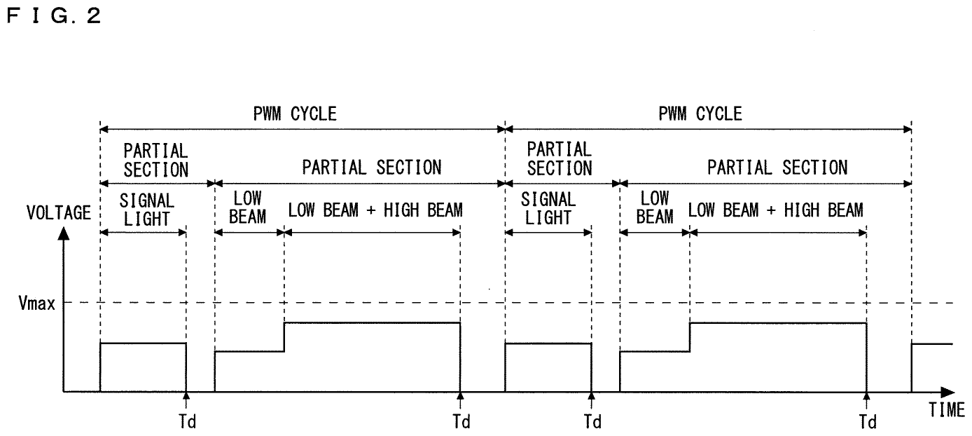

For example, Fl illustrates a timing diagram of an operation of the lighting control apparatus 10 in a case where the lighting control circuit 12 divides the plurality of semiconductor light sources 20 into a group of the low beam 20a and the high beam 20b and a group of the signal light 20c. A vertical axis in FIG. 2 indicates the output voltage of the switched-mode power supply 11 (corresponding to voltage drop occurring in the low beam 20a, the high beam 20b, and the signal light 20c), and a lateral axis indicates a time. FIG. 2 illustrates maximum output voltage Vmax of the switched-mode power supply 11. FIG. 2 illustrates an operation of the lighting control circuit 12 turning on all of the low beam 20a, the high beam 20b, and the signal light 20c.

As illustrated in FIG. 2, the cycle of the PWM control (referred to as “PWM cycle” hereinafter) is divided into a partial section allocated to the group of the signal light 200 and a partial section allocated to the group of the low beam 20a and the high beam 20b. In the partial section allocated to the group of the signal light 20c, the lighting control circuit 12 performs lighting control on the signal light 20c belonging to the group, and does not turn on the low beam 20a and the high beam 20b which do not belong to the group, In contrast, in the partial section allocated to the group of the low beam 203 and the high beam 20b, the lighting control circuit 12 performs lighting control on the low beam 20a and the high beam 20b belonging to the group, and does not turn on the signal light 20c which does not belong to the group. Thus, all of the low beam 20a, the high beam 206, and the signal light 20c are not turned on at the same time.

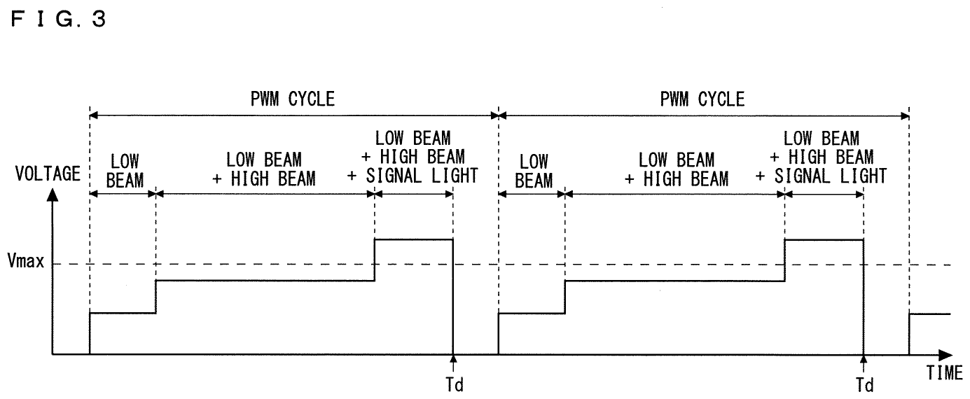

Herein, FIG. 3 illustrates, as a comparative example, a timing diagram of an operation in a case where the lighting control circuit 12 does not divide the low beam 20a, the high beam 20b, and the signal light 20c into the groups. In this case, all of the low beans 20a, the high beam 20b, and the signal light 20c may be turned on at the same time in the PWM cycle, At this time, as illustrated in FIG. 3, when the voltage required for turning on all of the low beam 20a, the high beam 20b, and the signal light 20c at the same time (corresponding to a total sum of the voltage drop occurring in the low beam 20a, the high beam 20b, and the signal light 20c) is larger than the maximum output voltage Vmax of the switched-mode power supply 11, the low beam 20a, the high beam 20b, and the signal light 20c are not normally turned on. In this case, the switched mode power supply 11 having high maximum output voltage needs to be prepared or two switched-mode power supplies 11 need to be prepared, and such a configuration leads to increase of a heat generation amount and increase of size of the lighting control apparatus.

In contrast, according to the lighting control apparatus 10 in the embodiment I, all of the low beam 20a, the high beam 20b, and the signal light 20c are not turned on at the same time, and the voltage drop occurring therein is prevented from exceeding the maximum output voltage Vmax of the switched-mode power supply 11; thus, occurrence of the problem of increase of the he it generation amount and increase of size of the lighting control apparatus describe ed above can be prevented.

When the plurality of semiconductor light sources 20 connected in series are driven by the PWM control, as illustrated in FIG. 2, the output voltage of the switched-mode power supply 11 fluctuates, and voltage st highest output voltage is retained in the smoothing capacitor 14 at a time of finishing the PWM cycle or finishing the partial section. When the process makes a transition to a next PWM cycle or partial section while such a state is kept, overcurrent flows in the semiconductor light source 20 firstly turned on, and the semiconductor light source 20 may be broken. Thus, the lighting control circuit 12 makes the discharge circuit 15 enter a conduction state before the PWM cycle is started or before the partial section is started, and discharges residual electrical charge in the output terminal of the switched-mode power supply 11, that is to say, electrical charge stored in the smoothing capacitor 14. For example, the electrical charge in the smoothing capacitor 14 may be discharged at a timing of finishing the lighting period of the semiconductor light source 20 in the partial section (a timing Td illustrated in FIG. 2)

Described in the embodiment 1 is the example of dividing the plurality of semiconductor light sources 20 toto the group of the low beam 20a and the high beam 20b and the group of the signal light 20c, that is to say, dividing the headlight and the signal light into the different groups; however, any division into groups may be performed. Since the headlight requires a large light emission amount and the lighting period needs to be long solely for the headlight, it is effective to divide the headlight and the signal light into the different groups.

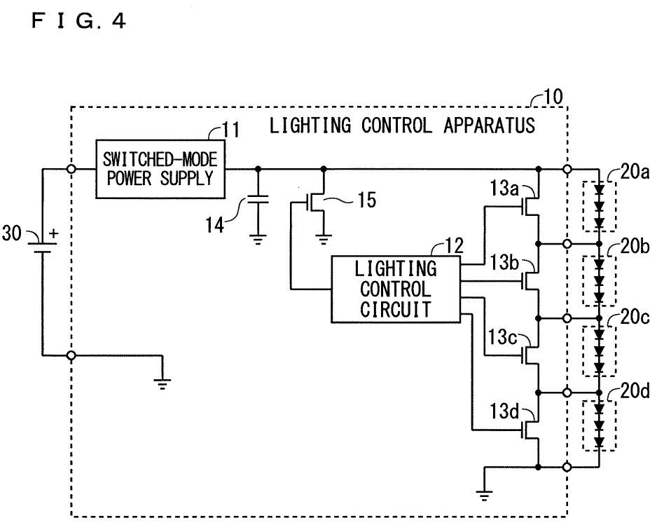

Although described in the embodiment 1 is the example that the lighting control apparatus 10 drives three semiconductor light sources 20, the lighting control apparatus 10 may drive four or more semiconductor light sources 20. FIG. 4 illustrates a configuration example in a case where the lighting control apparatus 10 drives four semiconductor light sources 20a, 20b, 20c, and 20d. The switch element controlled by the lighting control circuit 12 includes the switch elements 13a, 13b, and 13c and a switch element 13d connected in parallel to the semiconductor light sources 20a, 20b, 20c, and 20d, respectively.

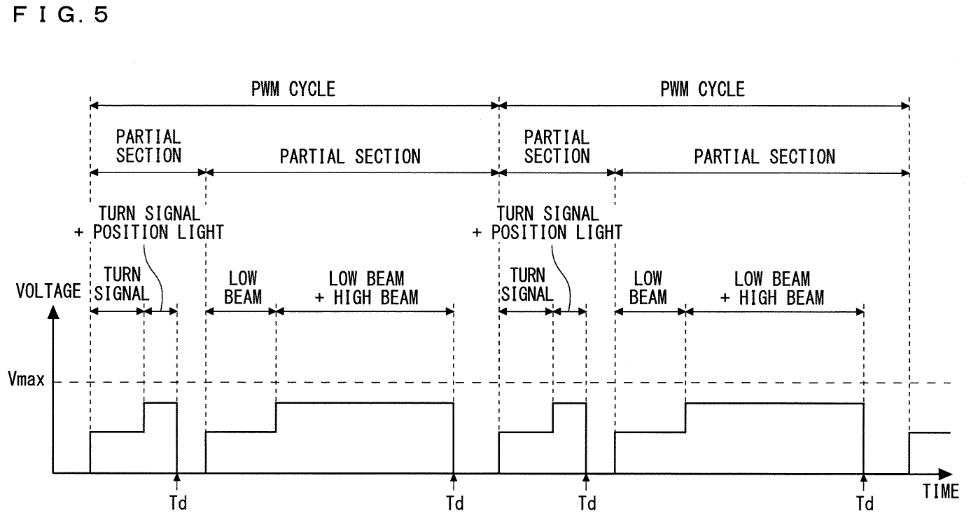

It is specifically assumed in FIG. 4 that the semiconductor light source 20a is the low beam of the headlight, the semiconductor light source 20b is the high beam of the headlight, the semiconductor light source 20c is a position light as one of the signal lights, and the turn signal 20d is a turn signal light as the other one of the signal lights, FIG. 5 illustrates a timing diagram of an operation of the lighting control apparatus 10 in a case where the lighting control circuit 12 divides the plurality of semiconductor light sources 20 into the group of the low beam 20a and the high beam 20b and a group of the position light 20c and the turn signal 20d. The effect similar to that described above can be obtained also in the case where the number of the semiconductor light sources 20 is four or more.

### Embodiment 2

A daylight has an effect of improving visibility of a pedestrian and a vehicle seen from the other vehicle during daytime, and a demand thereof has been recently increased. However, a light emission amount required by the semiconductor light source such as the daylight turned on during daytime is relatively large; thus, when the PWM cycle is divided into the plurality of partial sections as with the embodiment I, it is considered to be difficult to ensure the light emission amount required by the daylight. Particularly, when the headlight and the daylight are divided into different groups to suppress the voltage drop, such a problem becomes significant by reason that the long partial section of the group f the headlight needs to be ensured.

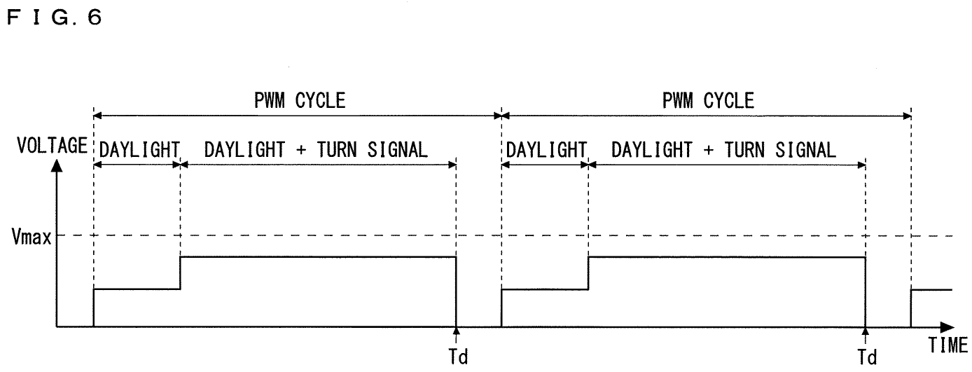

In the meanwhile, since the headlight needs not be turned on during daytime, it is hardly considered that the daylight is used together with the headlight. Thus, in the embodiment 2, the lighting control circuit 12 does not divide the plurality of semiconductor light sources 20 into the groups when the headlight is not turned on. FIG. 6 is a timing diagram illustrating an operation of the lighting control apparatus 10 in a case where the lighting control circuit 12 tums on the daylight and the turn signal without dividing the plurality of semiconductor light sources 20 into the groups. Since the plurality of semiconductor light sources 20 are not divided into the groups, the PWM cycle is not divided. An operation of the lighting control circuit 12 in a case where the headlight is turned on is similar to that according to embodiment 1.

According to the lighting control apparatus 10 in the embodiment 2, the plurality of semiconductor light sources 20 are not divided into the groups when the headlight is not turned on; thus, a long lighting period of the semiconductor light source such as the daylight turned on during daytime can be ensured. Such a configuration is effective by reason that a relatively large light emission amount is required by the semiconductor light source turned on during daytime.

Each embodiment can be arbitrarily combined, or each embodiment can be appropriately varied or omitted.

The foregoing description is in all aspects illustrative, and it is therefore understood that numerous modification examples not exemplified can be devised.

### EXPLANATION OF REFERENCE SIGNS

10 lighting control apparatus, 11 switched-mode power supply, 12 lighting control circuit, 13a to 13d switch element, 14 smoothing capacitor, 15 discharge circuit, 20a to 20d semiconductor light source

1. A lighting control apparatus, comprising:
a switched-mode power supply supplying voltage to a plurality of semiconductor light sources, including a headlight and a signal light, connected in series; and
a lighting control circuit driving the plurality of semiconductor light sources by pulse width modulation (PWM) control supplying output voltage of the switched-mode power supply to the plurality of semiconductor light sources in a cycle and controlling a width of a period in which the output voltage of the switched-mode power supply is supplied to each of the plurality of semiconductor light sources in each cycle of the PWM control to control a light emission amount of each of the plurality of semiconductor light sources, wherein
the lighting control circuit divides the plurality of semiconductor light sources into a plurality of groups and divides a cycle of the PWM control into a plurality of partial sections allocated to the plurality of groups, respectively, to divide a period in which the output voltage of the switched-mode power supply is supplied for each group.

2. The lighting control apparatus according to claim 1, wherein
the lighting control circuit divides the headlight and the signal light into groups different from each other.

3. The lighting control apparatus according to claim 1, wherein
when the headlight is not turned on, the plurality of semiconductor light sources are not divided into groups.

4. The lighting control apparatus according to claim 1, further comprising
a discharge circuit discharging residual electrical charge in an output terminal of the switched-mode power supply before the cycle of the PWM control is started or before the partial section is started.
